(19) United States
(12) Patent Application Publication
(10) Pub. No.: US 2001/0054157 A1
(43) Pub. Date: Dec. 20, 2001

(54) Computer network system and security guarantee method in the system

(75) Inventor: Yuji Fukumoto, Fuchu-shi (JP)

Correspondence Address: Finnegan, Henderson, Farabow,, Garrett & Dunner, L. L. P., 1300 I Street, N.W., Washington, DC, 20005-3315, US

(73) Assignee: KABUSHIKI KAISHA TOSHIBA

(21) Appl. No.: 09/793,085

(22) Filed: Feb. 27, 2001

(30) Foreign Application Priority Data
Jun. 8, 2000 (JP) 2000-172652

(51) Int. Cl. H04L 9/32

(52) U.S. Cl. 713/201; 709/227

(57) ABSTRACT

When a firewall receives, from a mobile terminal via the Internet, an access request which designates a URL including a http, a domain name containing a host name, a service name, a machine name, and a specific port number, the firewall outputs the request to a corresponding port of a relay server. The relay server sends an authentication page to the request source terminal to cause the user to input authentication data, and causes an authentication server to authenticate the request source user on the basis of the input authentication data. If authentication succeeds, the relay server checks whether the authenticated user can receive a service represented by the service name and machine name in the URL. If the user can receive the service, the relay server sets a session, and grants request/response communication between the mobile terminal of the request source and the request destination in the session.

### CROSS-REFERENCE TO RELATED APPLICATIONS

This application is based upon and claims the benefit of priority from the prior Japanese Patent Application No. 2000-172652 filed Jun. 8, 2000, the entire contents of which are incorporated herein by reference.

### BACKGROUND OF THE INVENTION

The present invention relates to a computer network system capable of accessing an internal network installed in a company or the like via an external network in a mobile environment and, more particularly, to a computer network system suitable for guaranteeing security in access from the outside to the inside, and a security guarantee method in the system.

Conventionally, a computer network system having an internal network (e.g., local area network) installed in, e.g., a company is accessed via an external network in a mobile environment mainly by the following two known methods.

In one method, a mobile telephone represented by a cellular phone or PHS (Personal Handy phone System) or a mobile terminal such as a PDA (Personal Digital Assistant) is used to connect by dialup to an access point prepared in the computer system of a company via a radio channel or line (public line network) as an external network. In the other method, the computer network system is accessed via the Internet as an external network.

In access using a radio channel or line, a one-time password can be utilized for authentication at the access point. To the contrary, in access to the company via the Internet, a network device such as a firewall for isolating an internal network from an external network (e.g., Internet) often denies access. Alternatively, a special Internet such as a VPN (Virtual Private Network) may be used in access. Alternatively, a firewall itself may authenticate a one-time password. Particularly recent mobile telephones have a function capable of accessing various Web home pages via the Internet. When company data is accessed using this function, it is necessarily done via the Internet. Hence, security must be enhanced by authenticating a one-time password or the like by a firewall or the like with respect to access via the Internet.

As described above, in the prior art, when a computer network system having a firewall serving as a network device for isolating an internal network from an external network is accessed via the Internet in a mobile environment, the firewall authenticates a one-time password or the like with respect to the access. This authentication can realize access of a rightful user to, e.g., an intra computer network system in a mobile environment, and can prevent illicit access by a third person. An example of ensuring network security using a firewall is disclosed in Jpn. Pat. Appln. KOKAI Publication No. 11-338799.

In the prior art, however, if a user is qualified as a rightful user as a result of authentication by a firewall, the user gains identical access right for subsequent accesses as if he/she was in a company as long as access is to an intra computer network system. This poses a security problem. Especially when the security of the firewall is broken, the user can access the internal network and intra computer to acquire all company data, resulting in serious damage.

### BRIEF SUMMARY OF THE INVENTION

It is an object of the present invention to provide a computer network system capable of limiting services the user can use in a mobile environment, and inhibiting access by even an authenticated user except for specific services, thereby minimizing damage even if an authentication error occurs, and a security guarantee method in the system.

According to the present invention, a computer network system comprises: a network device which isolates an internal network from an external network, monitors access from a terminal to the internal network via the external network, and controls grant/denial; at least one server which is connected to the internal network and provides an application that is accessed in response to an access request from the terminal; authentication means for receiving an access request from the terminal to the server that is granted by the network device, and authenticating a terminal user who has issued the access request; and access grant control means for granting access to an application granted to the user in advance with respect to the access request from the terminal user granted by the authentication means.

In this arrangement, when an access request from a terminal outside the system is received by a network device such as a firewall, the access request is transferred to the authentication means of an access management server. Upon reception of the access request, the authentication means of the access management server authenticates a user who has issued the access request. If authentication succeeds, and the user is recognized as a rightful user, the user is granted to access only for an access request to an application granted to the user in advance. Authentication can adopt, e.g., an authentication method using a one-time password.

In this manner, the present invention can employ the authentication means other than the firewall with respect to an access request via the Internet in a mobile environment. Even if authentication erroneously succeeds, only access of a specific user to a specific application, i.e., only a specific service is influenced.

The present invention preferably adds, to the system, session management/monitoring means for setting a session ID for every access request whose access is granted by the access grant control means, monitoring a time of the set session ID, and disconnecting access corresponding to a session ID which has not been accessed from the terminal for a predetermined time.

By performing session management/monitoring and disconnecting (log out) access to a session ID which has not been accessed for a predetermined time, authentication must be done for the next access. This can make illicit access difficult.

The present invention preferably adds a relay function of transferring an access request granted by the access grant control means, via the internal network to a server which provides an application subjected to the access request, and transferring a response to the access request from the server, to a terminal which has issued the access request.

Since the system has the request/response relay function between an external terminal and a server which provides an application, the terminal does not directly access the server which provides an internal application. This can further enhance security.

In the present invention, the access grant control means, the session management/monitoring means, each function of the relay means, and the function of authenticating using the authentication server a user who has issued an access request from a terminal are implemented by a relay server connected to the internal network. In this case, the network device and relay server are preferably connected by a special communication channel independent of the internal network. The network device preferably comprises access request delivery means which analyzes an access request from the terminal, and when the access request has location data including a specific protocol, a specific host name representing the relay server, and a specific port number representing a specific port of the relay server, sends the access request to the relay server. In this case, the specific protocol is preferably an http (hyper text transfer protocol).

In this arrangement, a specific access request from the terminal that is accepted by the network device is delivered to the relay server without the mediacy of the internal network. Even for an access request before authentication from an illicit user, any adverse influence of the access request on the system can be prevented.

In the present invention, a server machine has a function of connecting the terminal to the server which provides the application, and a conversion service function of converting data. Location data of the access request includes a machine name representing the server machine subjected to an access request, and a service name provided by the server. When the relay server relays the access request to the server, the relay server replaces the host name to the relay server with the machine name of the server.

Thus, the relay function of the relay server can be realized. Note that when the external network is the Internet, the type of data processed by the terminal is preferably an HTML (HyperText Markup Language). In this case, even if the terminal is a mobile terminal such as a cellular phone (mobile telephone), and does not incorporate any software capable of using various applications in the system, the applications can be used from the mobile terminal so far as data page browsing software (so-called Web browser) which processes HTML documents is installed.

Note that the aspect related to the computer network system can also be established as an aspect related to a method (security guarantee method in the computer network system).

The aspect related to the computer network system can also be established as a computer-readable storage medium which records a relay server program for causing a computer to execute procedures corresponding to the present invention (or causing the computer to function as means corresponding to the aspect, or causing the computer to realize functions corresponding to the aspect).

The present invention adopts the authentication security at a portion other than the network device for isolating an internal network from an external network, with respect to access from a mobile environment via the external network. A rightful user can access the internal network from the mobile environment. In addition, services usable by the user from the mobile environment are limited for each user, and even an authenticated user cannot access services except for a specific service. Even when authentication erroneously succeeds, the damage can be minimized. That is, the present invention can improve security while granting access from the mobile environment.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing the arrangement of an intra computer network system according to an embodiment of the present invention;

FIG. 2 is a view for explaining an outline of an access sequence when the user accesses an intra computer network system 1 from a mobile terminal 3 via the Internet 2;

FIGS. 3A and 3B are views for explaining a URL used in access to the intra computer network system 1 from the mobile terminal 3 via the Internet 2;

FIG. 4 is a view showing an example of a one-time authentication page;

FIGS. 5A and 5B are sequence charts for explaining details of the access sequence;

FIG. 6 is a flow chart for explaining details of the operation of a firewall (FW) 12;

FIG. 7 is a flow chart showing part of a flow for explaining details of the operation of a relay server 13;

FIG. 8 is a flow chart showing another part of the flow for explaining details of the operation of the relay server 13;

FIG. 9 is a flow chart showing the remaining part of the flow for explaining details of the operation of the relay server 13; and

FIG. 10 is a view showing a data structure of a management data area 100 of the relay server 13.

### DETAILED DESCRIPTION OF THE INVENTION

An embodiment in which the present invention is applied to an intra computer network system will be described below with reference to the several views of the accompanying drawing.

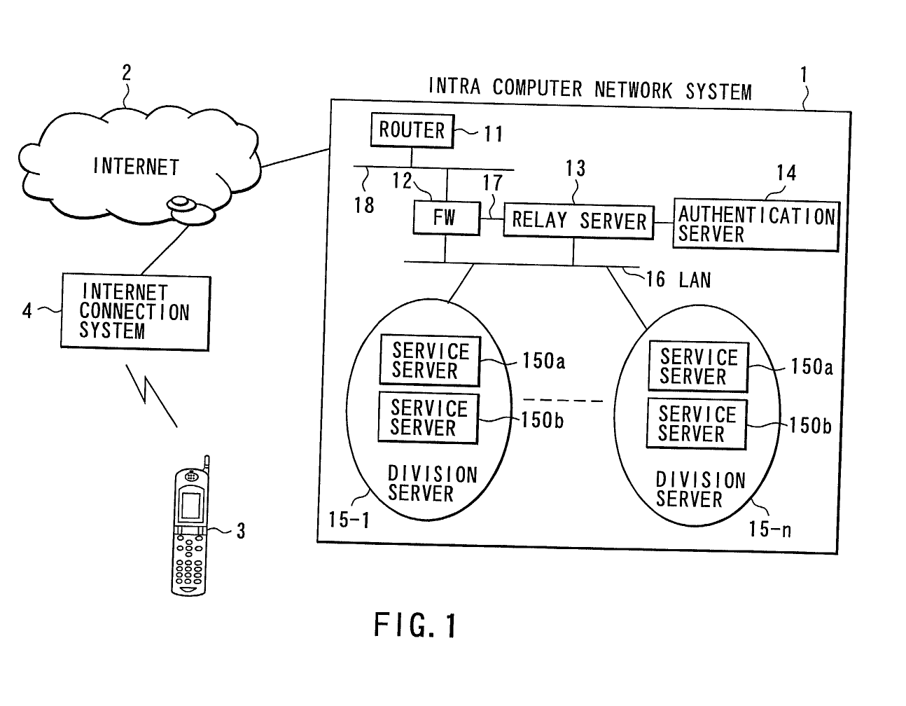

FIG. 1 is a block diagram showing the arrangement of the intra computer network system according to the embodiment of the present invention.

In FIG. 1, an intra computer network system 1 comprises a router 11, and is connected to the Internet 2 serving as an external network via the router 11. The Internet 2 is connected to an Internet connection system 4 for connecting a mobile terminal 3 such as a cellular phone to the Internet 2. A Web browser or the like for processing HTML documents is installed in the mobile terminal 3 such as a cellular phone, but various application software such as e-mail software used in a company or the like cannot be installed.

The intra computer network system 1 is constituted by a firewall (FW) 12 connected to the router 11, a relay server 13 having a security function which is enabled in access from the mobile terminal 3 to the intra computer network system 1, an authentication server 14 for authenticating an access request source user using the mobile terminal 3 in accordance with an instruction from the relay server 13, virtual division servers (generic name) 15-1 through 15-n which can provide various services and are prepared for, e.g., respective sections in a company, and a LAN (Local Area Network) 16 serving as an internal network for connecting connection service servers (to be simply referred to as service servers hereinafter) arranged in the division servers 15-1 through 15-n to the firewall 12, relay server 13, and division servers 15-1 through 15-n.

In the embodiment of FIG. 1, the relay server 13 and authentication server 14 are separated, but may be integrated as an access management server. The division servers 15-i (i=1, 2, 3, . . . ) generally name service servers 150a, 150b, . . . , and do not exist as hardware. As a server computer, at least one service server exists.

The firewall 12 serves as a network device for isolating the LAN 16 from the Internet 2. The firewall 12 and router 11 are connected via a LAN 18. The firewall 12 of the present invention has a function of, when it receives via the router 11 an external access request sent through the Internet 2, transferring the request to the relay server 13 via a communication channel 17 other than the LAN 16 on the basis of a URL (Uniform Resource Locator) appended to the request.

To realize the security function, the relay server 13 has a one-time password authentication cooperating function, authentication session managing/monitoring function, access relay (proxy) function, various service functions. Details of these functions are as follows.

The one-time password authentication cooperating function authenticates an access request source user by a one-time password in cooperation with the authentication server 14. To realize this, the relay server 13 has a one-time password issuing function of issuing a new password, e.g., every minute. The user of the mobile terminal 3 has a secure card for issuing the same password every minute in synchronism with the one-time password issuing function of the relay server 13.

The authentication session managing/monitoring function has a section managing function for managing an authenticated session to grant/deny an access request, and a session monitoring function of monitoring a session ID to confirm the presence/absence and authenticity of the session ID. The authentication session managing/monitoring function also has a function of transferring an access request to the access relay function for an authenticated session as a result of session management/monitoring with respect to the access request, and transferring an access request to the one-time password authentication cooperating function for an unauthenticated session.

The access relay (proxy) function determines the transfer destination of a request depending on a division server 15-i (i is any one of 1 to n) to which access is requested, and transfers the request to the destination division server 15-i as a result of determination.

The various service functions display and customize data pages corresponding to various services.

The division server 15-i is made up of, e.g., two service servers 150a and 150b which provide an application to which access is requested from the mobile terminal 3. The service servers 150a and 150b have a function of converting data provided by an application into HTML data which can be browsed by the mobile terminal 3, and a function of converting HTML data transmitted from the mobile terminal 3 into data of a format which can be processed by an application.

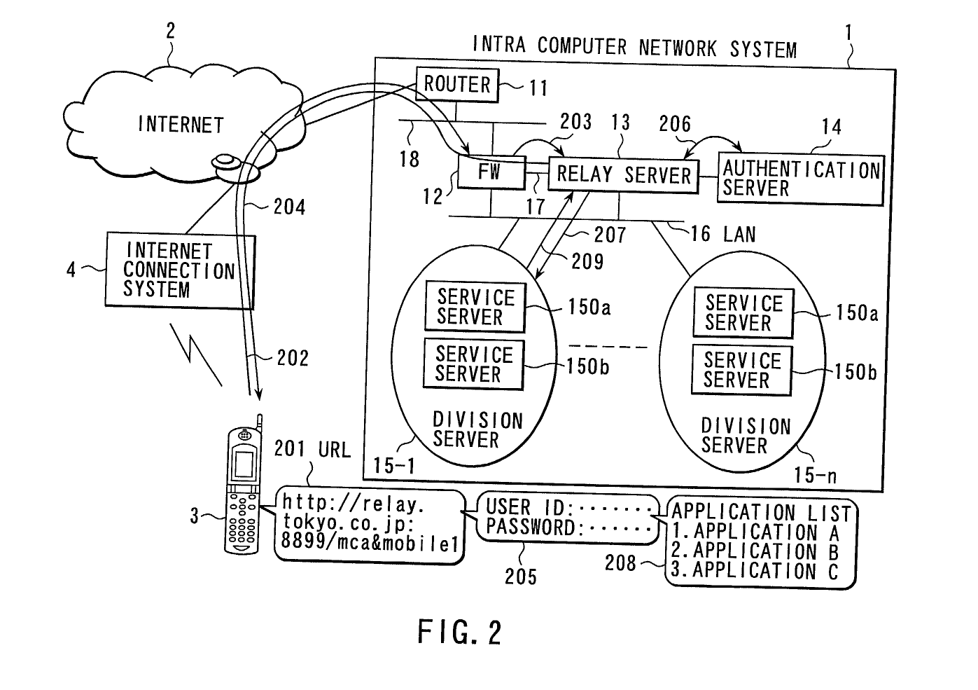

An outline of an access sequence when the user accesses from the mobile terminal 3 via the Internet 2 a service server 150j (j is a or b), e.g., service server 150a on the division server 15-i in the intra computer network system 1 in the arrangement of FIG. 1 will be described with reference to the operation explanatory view of FIG. 2.

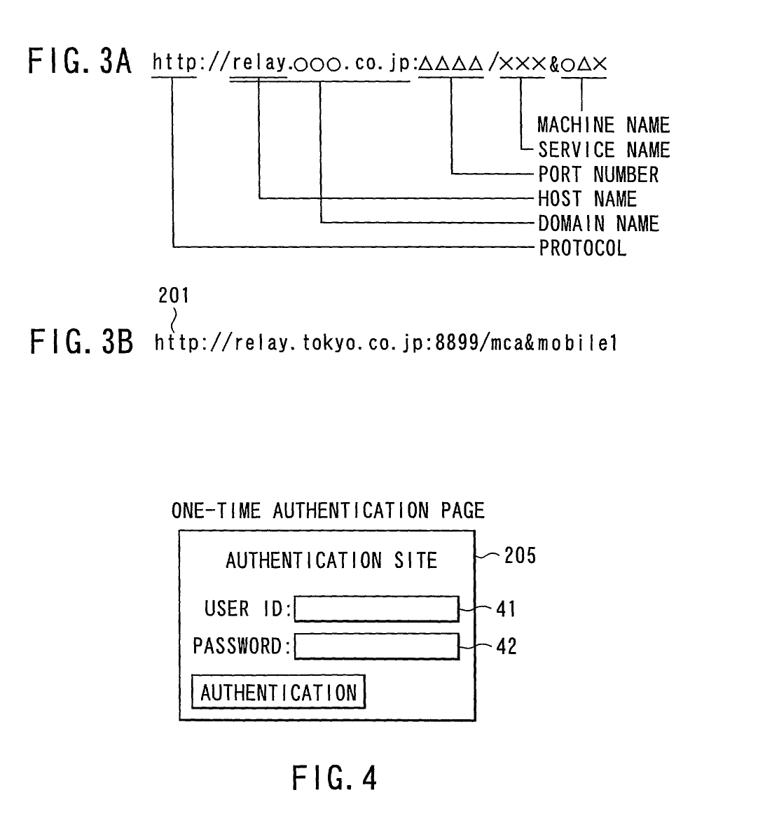

When the user accesses the intra computer network system 1 from the mobile terminal 3 via the Internet 2, he/she transmits an access request (http request) 202 which designates a URL 201 including an application protocol (resource type) http (hyper text transfer protocol) as shown in FIG. 3A, a domain name containing a host name, a service name representing a service server, the machine name of a division server in which the service server is located, and a port number.

Assuming that the user accesses the service server 150a (service name “mca”) located in the division server 15-1 (machine name=“mobile1”) in the intra computer network system 1, the URL 201 is

http://relay.tokyo.co.jp:8899/mca&mobile1

as shown in FIG. 3B. Items “relay”, “8899”, “mca”, and “mobile1” in the URL 201 mean

relay: host name representing the relay server 13

8899: port number of the service server 150a

mca: service name representing the service server 150a

mobile1: machine name representing the division server 15-1

The access request 202 is sent from the Internet connection system 4 to the Internet 2, received by the router 11 of the intra computer network system 1, and transferred to the firewall 12.

The firewall 12 analyzes the URL 201 of the received access request 202. Only when the URL 201 has the http protocol, host name “relay”, and port number “8899”, and a host name “relay” and port number “8899 ” are internally registered in advance, the firewall 12 transfers the access request 202 to the relay server 13, as indicated by reference numeral 203.

The relay server 13 checks whether the service name “mca” and machine name “mobile1” included in the URL 201 in the access request 202 coincide with a service name “mca” and machine name “mobile1” internally registered in advance. If the service names and machine names coincide with each other, the relay server 13 sends back to the mobile terminal 3 of the access request source via the firewall 12, as a response 204 to the access request 202, a one-time password authentication page (to be simply referred to as a one-time authentication page hereinafter) 205 in a format shown in FIG. 4 that also serves as a log-in page.

The user manipulates the mobile terminal 3 to input a user ID and one-time password on the one-time authentication page 205, and transmits them to the relay server 13. The relay server 13 authenticates the authenticity of the corresponding user on the basis of the received user ID and one-time password in cooperation with the authentication server 14.

If authentication by the authentication server 14 fails, the relay server 13 sends back a page which displays “access inhibition” to the mobile terminal 3 of the access request source. To the contrary, if authentication succeeds, and the service name “mca” and machine name “mobile1” designated by the URL 201 represent the service of the service server 150a and the machine name of the division server 15-1, the relay server 13 changes the host name “relay” in the URL 201 to the machine name “mobile1” in the URL 201. The access request 202 whose URL has changed is transferred from the relay server 13 to the division server 15-1 represented by the host name “mobile1” via the LAN 16, as indicated by reference numeral 207, and delivered to the service server 150a represented by the service name “mca” in the URL.

Then, the service server 150a generates an application selection page 208 including a list of connection serviceable applications, and sends it back to the relay server 13 as a response 209 with respect to the access request. The page 208 is relayed by the relay server 13, and sent back as a new response 204 to the mobile terminal 3 of the access request source via the firewall 12 and Internet 2.

The mobile terminal 3 of the access request source can use the relay function of the relay server 13 to access the service server 150a located in the division server 15-1 in the intra computer network system 1 via the Internet 2 and to selectively use one of applications provided by the service server 150a.

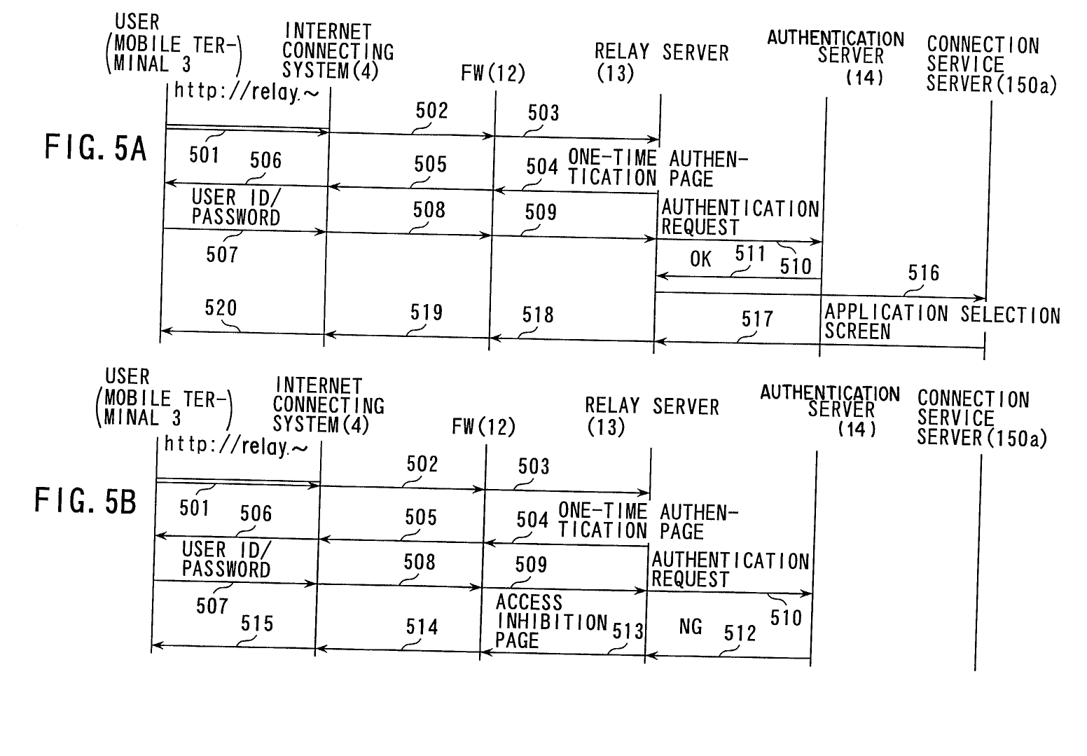

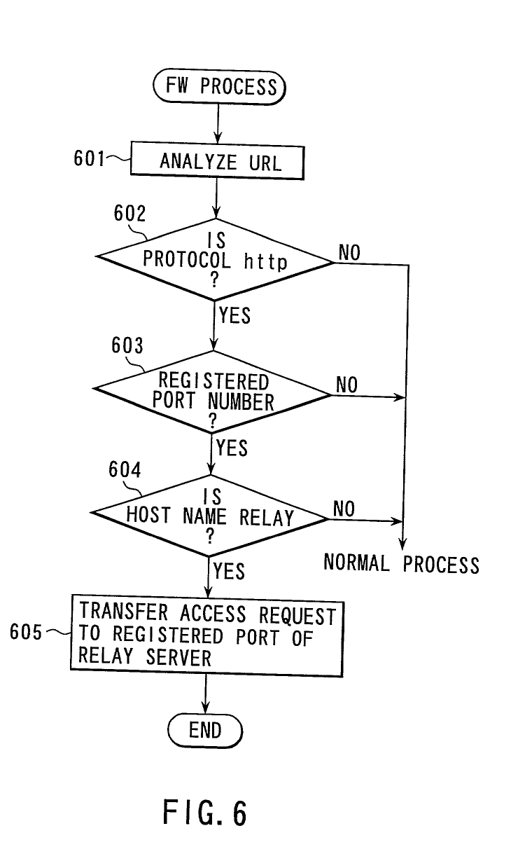

Details of this access sequence will be explained including session management/monitoring in the relay server 13 with reference to the sequence charts of FIGS. 5A and 5B and the flow charts of FIGS. 6 to 9.

In accessing the service server 150a located in the division server 15-1 in the intra computer network system 1 from the mobile terminal 3 via the Internet 2, the URL 201 such as

http://relay.tokyo.co.jp:8899/mca&mobile1

in other words, an access request (http request) which designates the URL 201 shown in FIG. 3B is transmitted from the mobile terminal 3, as indicated by an arrow 501 in FIGS. 5A and 5B.

The access request from the mobile terminal 3 is sent from the Internet connection system 4 to the Internet 2, as indicated by an arrow 502 in FIGS. 5A and 5B. This access request is received by the router 11 of the intra computer network system 1, and sent from the router 11 to the firewall (FW) 12.

The firewall 12 analyzes the URL 201 in the access request (step 601). If the protocol designated by the URL is “http”, the port number coincides with a port number “8899” which has been set and registered in boot-up, and the host name coincides with “relay” (steps 602 to 604 in FIG. 6), the firewall 12 transfers the access request to a port access request URL represented by the registered port number of the relay server 13 via the communication channel 17, as indicated by an arrow 503 in FIGS. 5A and 5B (step 605). Since the registered port number is “8899” in this example, the firewall 12 transfers the access request to a port of the relay server 13 having the port number “8899” in accordance with “http”, “relay”, and “8899” in the URL 201.

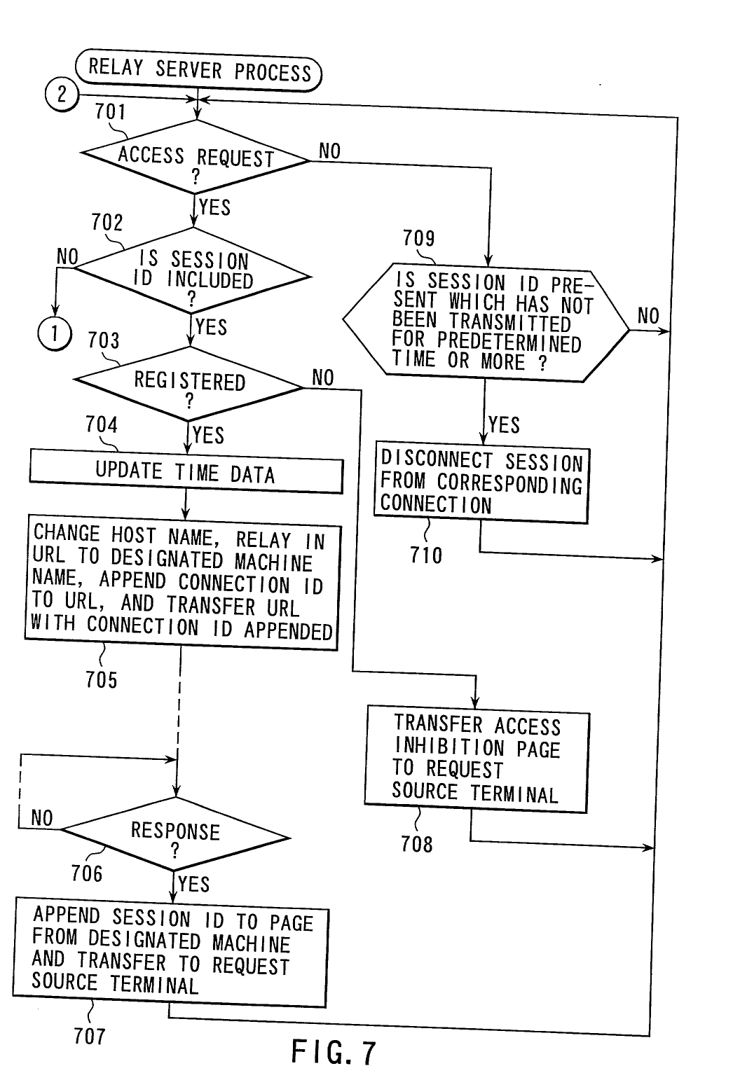

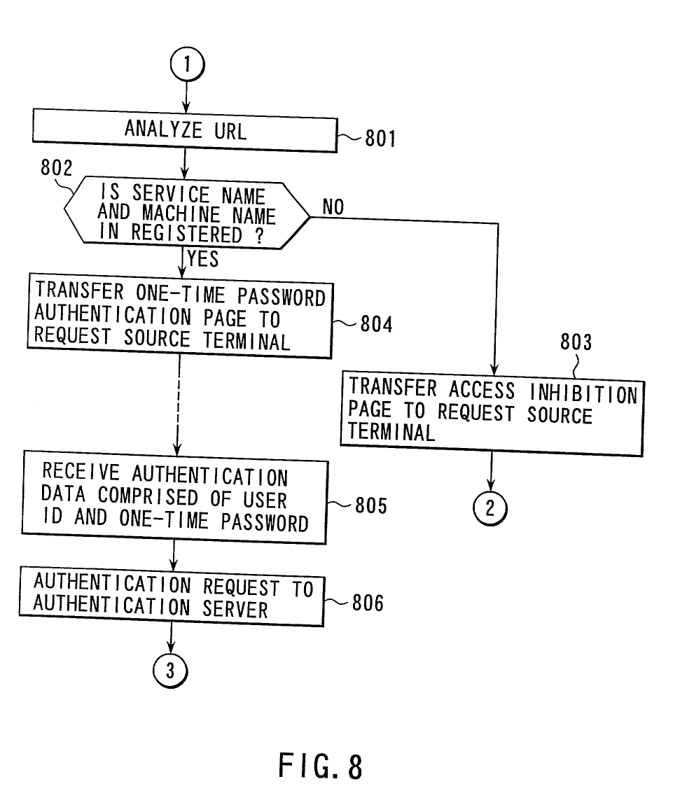

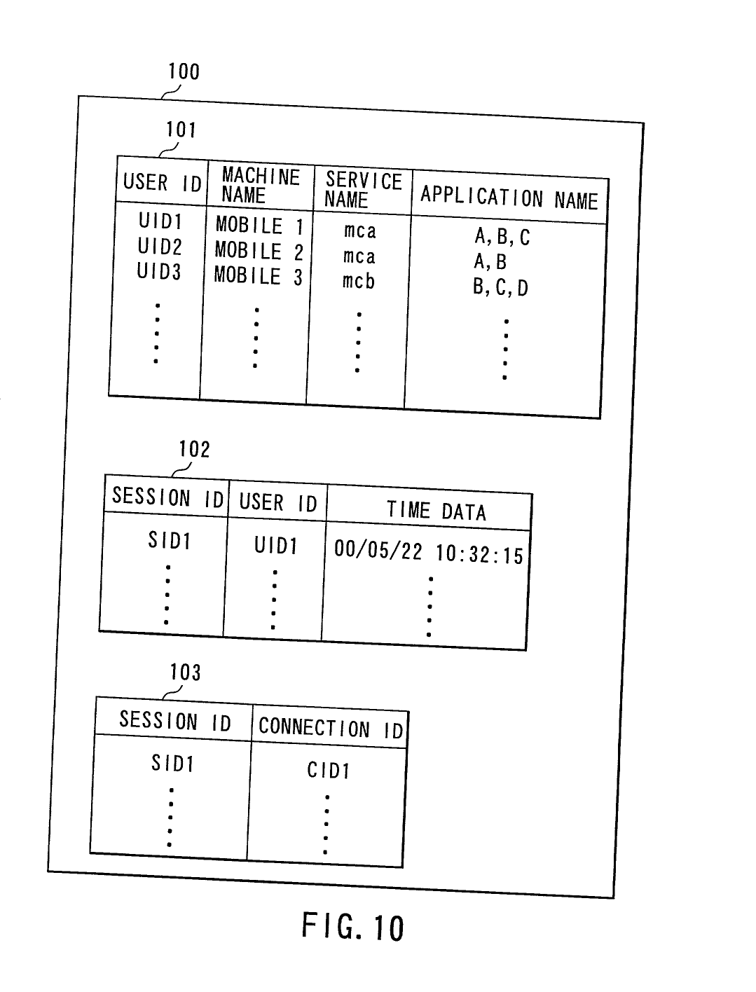

The relay server 13 is set in boot-up to wait for an access request at the port having the port number “8899”. Thus, if the relay server 13 receives the access request having the URL 201 at the port having the port number “8899” (step 701 in FIG. 7), the relay server 13 analyzes the URL in the access request, and checks whether the service name and machine name designated by the URL are registered in an internal user service list 101 (see FIG. 10) (steps 801 and 802 in FIG. 8).

If the service name and machine name designated by the URL are not registered in the user service list 101, the relay server 13 determines that the service request cannot be accepted, and transfers a page which displays “access inhibition” to the mobile terminal 3 to display the page (step 803).

To the contrary, if the service name and machine name designated by the URL are registered in the user service list 101, the relay server 13 determines that the service request may be accepted. In this case, the relay server 13 transfers the log-in one-time authentication page 205 of the HTML format shown in FIG. 4 to the mobile terminal 3 of the access request source via the firewall 12, Internet 2, and Internet connection system 4, and displays the authentication page 205 by a Web browser, as indicated by arrows 504 through 506 in FIGS. 5A and 5B (step 804).

This example assumes that the service name “mca” and machine name “mobile1” are registered in the user service list 101 for a user having a user ID “UID1”. Therefore, the relay server 13 sends the one-time authentication page 205 to the mobile terminal 3 of the access request source.

As shown in FIG. 4, the one-time authentication page 205 has a user ID input field (to be referred to as a user ID field) 41, and a password (one-time password) input field (to be referred to as a password field) 42. When the type of applied browser changes on the terminal, e.g., the mobile terminal 3 uses a user terminal other than a mobile device, the relay server 13 checks the browser type of the access request source, and sends a one-time authentication page coping with the browser type.

The user of the mobile terminal 3 holds a predetermined secure ID card (not shown) which updates and issues a one-time password at a predetermined time interval. The user manipulates the mobile terminal 3 to input a one-time password issued by the ID card to the password field 42 on the one-time authentication page 205 in FIG. 4, and to input his/her user ID “UID1” to the user ID field 41. The user manipulates the mobile terminal 3 to send back the input authentication to the relay server 13.

Then, the authentication data comprised of the user ID and one-time password input by the access request source user is transferred to the relay server 13 via the Internet connection system 4, the Internet 2, and the firewall 12 of the intra computer network system 1, as indicated by arrows 507 through 509 in FIGS. 5A and 5B.

If the relay server 13 receives the authentication data of the access request source user transferred from the mobile terminal 3 (step 805), the relay server 13 uses a known API (Application Program Interface) to request authentication processing using the authentication data of the authentication server 14, as indicated by an arrow 510 in FIGS. 5A and 5B (step 806).

The authentication server 14 has a one-time password issuing function of issuing the same one-time password as that of the user's secure ID card at the same time interval.

If the authentication server 14 receives the authentication processing request from the relay server 13, the authentication server 14 compares the password of the access request source user in the authentication data with a one-time password output from the one-time password issuing function, and checks whether these passwords coincide with each other. In this manner, the access request source user is authenticated. If the passwords coincide with each other, the authentication server 14 notifies the relay server 13 -of authentication success (OK) representing that the access request source user is a rightful user, as indicated by an arrow 511 in FIG. 5A. If the passwords do not coincide with each other, the authentication server 14 notifies the relay server 13 of authentication failure (NG) representing that the access request source user is not a rightful user, as indicated by an arrow 512 in FIG. 5B.

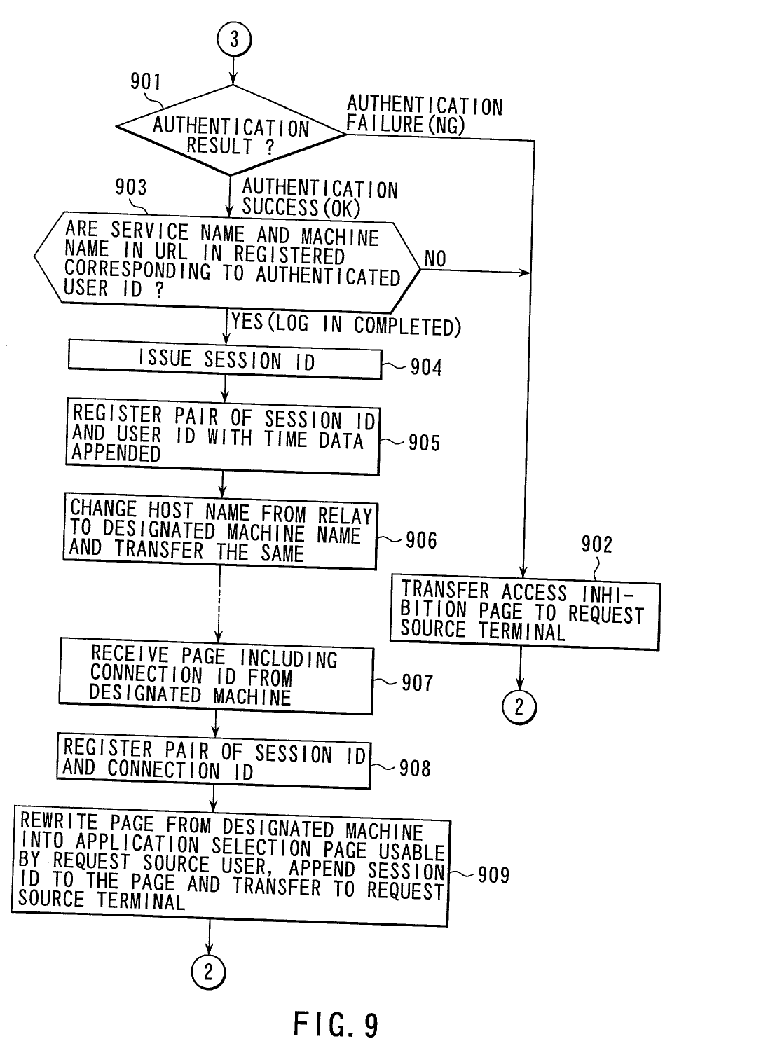

If the relay server 13 is notified of authentication failure from the authentication server 14 (step 901 in FIG. 9), the relay server 13 transfers an access inhibition page representing “access inhibition” to the mobile terminal 3 of the access request source user via the firewall 12, Internet 2, and Internet connection system 4, as indicated by arrows 513 through 515 in FIG. 5B (step 902).

To the contrary, if the relay server 13 is notified of authentication success from the authentication server 14 (step 901), the relay server 13 checks whether the service name and machine name designated by the URL in the access request represent a service server and division server which can be used in access to the intra computer network system 1 (step 903). Processing in step 903 will be described in detail.

The internal memory (not shown) of the relay server 13 in this embodiment comprises a management data area 100 having a data structure shown in FIG. 10. A user service list 101, session management table 102, and session/connection management table 103 are registered in the management data area 100. For all users accessible from external networks, a correspondence between the user ID of each user, and all service names, application names, and machine names usable by the user is registered in the user service list 101. In step 903, the relay server 13 checks whether the service name and machine name designated by the URL are registered in the user service list 101. The relay server 13 can determine whether the user has a right of receiving the service designated by the URL by the division server designated by the URL.

If no service name and machine name designated by the URL are registered in the user service list 101, i.e., the access request of the user is outside the range of granted services, the relay server 13 determines that the log in by the user fails, and transfers an access inhibition page to the mobile terminal 3 of the access request source user (step 902).

If the service name and machine name designated by the URL are registered in the user service list 101, i.e., the access request of the user falls within the range of granted services, the relay server 13 issues a unique session ID in correspondence with the user ID of the user in order to register that the log in of the user succeeds (step 904).

In this example, the service name and machine name designated by the URL are “mac” and “mobile1”, as shown in FIG. 3B, and are registered in the user service list 101 in correspondence with the user ID “UID1”, as shown in FIG. 10. Thus, the relay server 13 issues an unregistered session ID (SID1).

As shown in FIG. 10, a pair of a session ID representing an authenticated session and the corresponding user ID is registered in the session management table 102 of the management data area 100 of the relay server 13. If the relay server 13 issues an unregistered session ID (SID1) in step 904, it appends data of, e.g., the registration time (00/05/22 10:32:15) to the pair of the session ID (SID1) and the corresponding user ID (UID1), and registers them in the table 102 (step 905).

The relay server 13 changes the host name in the URL from the access request source terminal 3 from “relay” to the machine name “mobile1” designated by the URL, changes the URL to a format interpretable by the service server 150a, and transfers the host name to the service server 150a via the LAN 16 (step 906). In this case, the URL is changed to http://mobile1.tokyo.co.jp/mca. Then, the service request is transferred to the service server 150a of the division server 15-1, as indicated by an arrow 516 in FIG. 5A.

If the service server 150a of the division server 15-1 receives the access request URL, it generates an application selection page 208 including a list of serviceable application names, and transfers it to the relay server 13, as indicated by an arrow 517 in FIG. 5A.

If the relay server 13 receives the application selection page 208 including a connection ID (CID1) from the service server 150a on the division server 15-1 (step 907), the relay server 13 registers the connection ID (CID1) and session ID (SID1) in the session/connection management table 103 shown in FIG. 10 in correspondence with each other (step 908). The relay server 13 rewrites the application selection page 208 sent from the service server 150a into an application selection page usable by the access request source user, and replaces the connection ID (CID1) included in the page 208 with the corresponding session ID (SID1). Also, the relay server 13 transfers the application selection page 208 with the session ID (SID1) appended, as indicated by arrows 518 to 520 in FIG. 5A, and displays the page 208 on the mobile terminal 3 of the access request source (step 909).

Rewrite of the application selection page 208 by the relay server 13 is done as follows. The relay server 13 accesses the user service list 101 on the basis of the user ID (UID1) of the access request source user, and extracts a list of all application names registered in correspondence with the user ID. The relay server 13 compares the list of registered application names with a list of application names on the application selection page 208. If the relay server 13 detects an application name not present in application names registered in the user service list 101, the relay server 13 deletes this application name from the list of application names on the application selection page 208. As a result, the list of application names on the application selection page 208 include only application names usable by the access request source user. In this embodiment, applications serviceable by the connection service server 150a are A, B, and C. In this case, applications usable by the user having the user ID (UID1) are A, B, and C, as shown in FIG. 10, so that all applications connection-serviceable by the service server 150a are left in the application selection page 208.

The access request source user manipulates the mobile terminal 3 to select a desired application name from the list of application names on the application selection page 208 displayed on the mobile terminal 3. Then, the mobile terminal 3 transmits an access request URL which is an access request to the application selected by the user and designates a domain name including a host name, a port number, a service name, and a machine name. The mobile terminal 3 appends the session ID (SID1) to this access request URL, and transmits the access request.

Similar to the first access request, the access request with the session ID (SID1) appended that is transmitted from the mobile terminal 3 is transferred to the intra computer network system 1 via the Internet connection system 4 and Internet 2, received by the firewall 12 in the system 1, and sent to the relay server 13 via a registered port.

If the access request from the mobile terminal 3 is delivered to a port of the relay server 13 having a port number “8899” (step 701), the relay server 13 checks whether the session ID (SID1) is appended to the access request (step 702). If the session ID (SID1) is appended, like this example, the relay server 13 refers to the session management table 102 to check whether a user ID (UID1) corresponding to the session ID (SID1) is registered (step 703). If the user ID (UID1) is registered, time data appended to the pair of session ID (SID1) and user ID (UID1) is updated to the current time (step 704). In this case, time data appended to the pair of SID1and UID1 is updated.

Similar to step 906, the relay server 13 changes the host name in the URL from the access request source terminal 3 from “relay” to a machine name “mobile1” representing the division server 15-1. The relay server 13 appends a connection ID (CID1) corresponding to the session ID (SID1) with reference to the session/connection management table 103, and transfers the URL to the service server 150a via the LAN 16 (step 705).

If the service server 150a of the division server 15-1 receives the access request URL from the mobile terminal 3, the service server 150a is connected to the request source application, and receives response data for the access request from the application. The service server 150a converts the received response data into HTML page data processable by the mobile terminal 3 of the access request source, appends the connection ID (CID1) to the page data, and transfers the resultant page data to the relay server 13 via the LAN 16.

In this way, the relay server 13 and the service server 150a on the division server 15-i (15-1) communicate with each other using a connection (virtual line) designated by the connection ID (CID1).

If the relay server 13 receives the page data as response data from the service server 150a on the division server 15-1 (step 706), the relay server 13 replaces the connection ID (CID1) appended to the page data with a corresponding session ID (SID1) with reference to the session/connection management table 103, and transfers the page data with the session ID (SID1) appended, to the mobile terminal 3 of the access request source user via the firewall 12, Internet 2, and Internet connection system 4 (step 707).

Thus, the mobile terminal 3 of the access request source and the relay server 13 communicate with each other using a session (virtual line) designated by the session ID (SID1) issued in correspondence with the user ID (=UID1) of the user of the mobile terminal 3.

Similarly, the operation of monitoring by the relay server 13 data exchange between the mobile terminal 3 and the service server 150a on the division server 15-1, converting a host name or the like, and transferring an access request (URL) and page data is repeated.

If the relay server 13 receives an access request with a session ID appended (step 702), but this session ID is not registered in the session management table 102 (step 703), the relay server 13 transfers an access inhibition page to the mobile terminal 3 of the access request source (step 708). This can prevent illicit access using an illicit session ID.

While the relay server 13 does not process an access request from the mobile terminal 3, the relay server 13 periodically refers to, e.g., the session management table 102 to check whether a session ID is present which has not been transmitted for a predetermined time or more (step 709). More specifically, the relay server 13 compares time data appended to all session IDs registered in the session management table 102 with the current time, and checks whether each difference is the predetermined time or more. If the relay server 13 detects a session ID which has not been transmitted for the predetermined time or more, i.e., a session ID (connection) which has not been used for communication for the predetermined time or more, the relay server 13 sets the session ID as time out (log out), and deletes a pair of session ID and corresponding user ID from the session management table 102. Further, the relay server 13 deletes a pair of session ID and corresponding connection ID from the session/connection management table 103, and disconnects the session represented by the session ID from the connection corresponding to the session (step 710).

In the above embodiment, user authentication is performed once in connecting the relay server 13, i.e., a one-time authentication page is used as a log-in page. However, the present invention is not limited to this. For example, when one-time authentication succeeds, a log-in page which causes an authenticated user to input a user ID and password again may be sent to the mobile terminal 3 of the user to execute user authentication again. This password is preferably, e.g., a fixed password which is different from a one-time password and unique to the user.

In the above embodiment, an access request and response between the firewall 12 and the relay server 13 are transferred via the communication channel 17 in order to more reliably ensure security. However, the present invention is not limited to this, and they may be transferred via the LAN 16.

In the above embodiment, the present invention is applied to an intra computer network system. However, the present invention can be applied to an entire computer network which includes an internal network and has a function of isolating the internal network from an external network such as the Internet 2.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A computer network system comprising:
a network device which isolates an internal network from an external network, monitors access from a terminal to the internal network via the external network, and controls grant/denial;
at least one server which is connected to the internal network and provides an application that is accessed in response to an access request from the terminal;
authentication means for receiving an access request from the terminal to said server that is granted by said network device, and authenticating a terminal user who has issued the access request; and
access grant control means for granting access to an application granted to the user in advance with respect to the access request from the terminal user granted by said authentication means.

2. A system according to claim 1, further comprising session management/monitoring means for setting a session ID for every access request whose access is granted by said access grant control means, monitoring a time of the set session ID, and disconnecting access corresponding to a session ID which has not been accessed from the terminal for a predetermined time.

3. A system according to claim 1, wherein said access grant control means transfers the granted access request to said server via the internal network, and transfers a response from said server with respect to the access request to the terminal which has issued the access request.

4. A system according to claim 3, wherein location data including a host name is set in the access request output from the terminal to said network device, and when said access grant control means transfers the access request to said server, a host name to said access grant control means that is designated in the host name is changed to a machine name of said server.

5. A computer network system comprising:
a network device which isolates an internal network from an external network, monitors access from a terminal to the internal network via the external network, and controls grant/denial;
at least one server which is connected to the internal network and provides an application that is accessed in response to an access request from the terminal;
an authentication server for authenticating a user who has issued the access request from the terminal; and
a relay server connected between said network device and said server, said relay server receiving an access request from the terminal to said server that is granted by said network device, requesting said authentication server to authenticate a user who has issued the access request, granting access to an application granted to the user in advance with respect to the access request from the terminal user granted by said authentication means, transferring via the internal network the granted access request to said server which provides the application, and transferring a response from said server with respect to the access request to the terminal which has issued the access request.

6. A system according to claim 5, wherein said relay server sets a session ID for every granted access request, monitors a time of the set session ID, and disconnects access corresponding to a session ID which has not been accessed from the terminal for a predetermined time.

7. A system according to claim 5, further comprising a special communication channel which connects said network device and said relay server, and is used for communication between said network device and said relay server that includes transfer of the access request.

8. A system according to claim 5, wherein said network device comprises access request delivery means which analyzes an access request from the terminal, and when the access request is determined to have location data including at least a specific protocol, a host name representing said relay server, and a specific port number representing a specific port of said relay server, sends the access request to said relay server.

9. A system according to claim 8, wherein when said relay server transfers the access request to said server, a host name of said relay server designated by the host name is changed to a machine name of said server.

10. A security guarantee method in a computer system, comprising the steps of:
causing a network device which isolates an internal network from an external network to monitor access from a terminal to the internal network via the external network, and to control grant/denial;
receiving an access request from the terminal to a server connected to the internal network that is granted by the network device, and authenticating a terminal user who has issued the access request; and
granting access to an application in the server that is granted to the user in advance with respect to the access request from the terminal user whose access to the server is granted.

11. A method according to claim 10, further comprising:
setting a session ID for every granted access request;
monitoring a time of the set session ID; and
disconnecting access corresponding to a session ID which has not been accessed from the terminal for a predetermined time.

12. A method according to claim 10, further comprising:
transferring to the server via the internal network an access request from the terminal user whose access is granted by authentication of the terminal user, and
transferring a response from the server with respect to the access request to the terminal which has issued the access request.

13. A security guarantee method in a computer system, comprising the steps of:
causing a network device which isolates an internal network from an external network to monitor access from a terminal to the internal network via the external network, and to control grant/denial;
receiving an access request from the terminal to a server connected to the internal network that is granted by the network device, and authenticating a terminal user who has issued the access request;
granting access to an application granted to the user in advance with respect to the access request from the terminal user whose access to the server is granted, and transferring the access request via the internal network to the server which provides the application; and
receiving a response from the application of the server, and transferring the response to the terminal which has issued the access request.

14. A method according to claim 13, further comprising:
causing a relay server to set a session ID for every granted access request;
causing the relay server to monitor a time of the set session ID; and
causing the relay server to disconnect access corresponding to a session ID which has not been accessed from the terminal for a predetermined time.

15. A method according to claim 13, further comprising the step of:
causing the network device to determine that location data including at least a specific protocol, a host name representing the relay server, and a specific port number representing a specific port of the relay server is set.

16. A computer-readable storage medium which records a relay server program applied to a relay server of a computer network system having a network device which isolates an internal network from an external network, monitors access from a terminal to the internal network via the external network, and controls grant/denial, at least one server which is connected to the internal network and provides an application that is accessed in response to an access request from the terminal, an authentication server for authenticating a terminal user, and the relay server interposed between the network device and the server, wherein said storage medium records a relay server program for causing a computer to execute the steps of:
receiving an access request from the terminal to the server that is granted by the network device, and requesting the authentication server to authenticate a user who has issued the access request;
granting access to an application granted to the user in advance with respect to the access request from the terminal user granted by the authentication server; and
transferring the granted access request to the server which provides the application.
